(19) United States
(12) Patent Application Publication
(10) Pub. No.: US 2026/0340223 A1
(43) Pub. Date: Oct. 29, 2026

(54) A METHOD FOR ESTIMATING THE OPTIMUM ARRANGEMENT OF ENERGY CONDUITS IN AN ARRAY

(71) Applicant: KINEWELL ENERGY LTD, Newcastle Upon Tyne, Tyne And Wear (GB)

(72) Inventor: Andrew JENKINS, Newcastle upon Tyne, Tyne and Wear (GB)

(73) Assignee: KINEWELL ENERGY LTD, Newcastle Upon Tyne, Tyne And Wear (GB)

(21) Appl. No.: 19/481,925

(22) PCT Filed: May 9, 2024
(86) PCT No.: PCT/EP2024/062874

§ 371 Date: Nov. 6, 2025

(30) Foreign Application Priority Data
May 9, 2023 (EP) 23172406.3

(51) Int. Cl. G06F 30/20; G06F 17/11; G06F 111/10; G06F 113/16

(52) U.S. Cl. CPC G06F 30/20; G06F 17/11; G06F 2111/10; G06F 2113/16

(57) ABSTRACT

A Method for Estimating the Optimum Arrangement of Energy Conduits in an Array A method for estimating an optimum arrangement of energy conduits (cables) in an inter-array is disclosed. A non-deterministic mixed integer non-linear programming algorithm is used and is setup to produce an output including an arrangement of cables and an associated objective function value. Multiple processors or computers run calculations of the algorithm in parallel to produce a multiplicity of outputs using the same problem definition, the same stopping criteria but using different seeds. The outputs are analysed to determine the best objective function value and the arrangement of energy conduits associated therewith in particular considering the cost associated with power loses.

The present invention relates to a method for estimating the optimum arrangement of energy conduits in an array and relates particularly, but not exclusively, to a method for determining the best layout for power cables between turbines in an offshore wind farm bearing in mind factors such as power losses.

In an offshore wind farm cables are used to connect the individual turbines back to an onshore location. This is typically done via one or more nodes or collection substations and cables commonly connect one turbine to another in a chain before connection to a node (substation). The cable system that connects the turbines to the nodes (substations) is commonly called the inter-array system. With each turbine typically producing megawatts of power the cables to convey that power must be large and are expensive per unit length. Furthermore, with turbines typically placed a kilometre away from each other the total length of cable used between the tens to hundreds of turbines is significant. Where one turbine is linked to another the cable from the second turbine (which is closer to the substation) is carrying the power from both turbines and must therefore have the ability to carry a greater capacity than that required from a single turbine. Due to the significant cost of these cables (typically more than 10% of total wind farm capital expenditure), it is important that the right type of cable is selected for connection and that the most efficient layout is also selected. This efficiency includes total length of cable, cost of installation but also the potential for power loss from the cable measured and unavailability losses over its anticipated lifetime of use.

It is important that the mathematical model considers the real world phenomena and constraints as accurately as possible. If the system is modelled inaccurately, then even the globally optimal solution may end up being poor or infeasible for real-world applications.

Systems which are used to optimise the layout of cables in an array are disclosed in the following documents. CN113011090A presents a method involving the generation of Voronoi adaptive zones and using particle swarm optimisation to find a cable connection layout. The disadvantages to this approach include that it can take a long time to find an optimal cable layout, and the solution found could be a local maximum rather than a global maximum. CN111754035A (or WO2021253291A1) also describes a method for optimising a wind farm layout using meta-heuristic algorithms, with a focus on optimising substation coordinates. This document considers nonlinear power losses including resistive and dielectric losses within the objective function. In a further example from the patent literature, CN114580725A details a genetic based algorithm for the specific application of photovoltaic wiring. The algorithms are typically run for a long period of time to increase the chance of finding the optimum solution.

In “A review of offshore wind farm layout optimization and electrical system design methods”, Hou et al, Journal of Modern Power Systems and Clean Energy (Volume: 7, Issue: 5, September 2019) there is set out a review of several approaches to inter-array cable layout optimisation. The review includes classical deterministic approaches which fail to find a solution in reasonable time, if at all, without significantly simplifying the problem and reducing the accuracy of the results. Many methods disclosed in this review turn out to be non-deterministic, heuristic algorithms to avoid making simplifications. However, it is typical for these algorithms to be run for very long periods of time to obtain a solution as close to optimal as possible.

The work in “Heuristic algorithms for the Wind Farm Cable Routing problem”, Cazzaro et al, (https://www.researchgate.net/publication/343567214) compares several heuristic algorithms to a set of cable layout optimisation problems and demonstrates the variability of results obtained through prior art stochastic algorithms. These example approaches make it difficult to know whether a good result was obtained due to a change in inputs, a change in algorithm configuration, or just by chance.

Another example of a system that aims to optimise a cable layout is discussed in Fischetto Martina et al: “Optimising wind farm cable routing considering power losses” in the European Journal of Operational Research volume 270, no. 3, pages 917 to 930. As the title suggests the important consideration of power losses is addressed in the method disclosed in this publication.

Preferred embodiments of the present invention seek to overcome or alleviate the above described disadvantages of the prior art.

According to an aspect of the present invention there is provided a method for estimating an optimum arrangement of energy conduits in an array, comprising the steps:
setting up, on at least one computing device, a non-deterministic mixed integer non-linear programming algorithm to optimise an arrangement of energy conduits in an array as a non-linear optimisation problem, the algorithm producing an output including at least one arrangement of energy conduits and an associated objective function value;
performing, on said at least one computer device, a calculation of said algorithm a multiplicity of times, in parallel, to produce a multiplicity of outputs using substantially the same problem definition, using substantially the same stopping criteria and using different seeds; and
analysing, on a said or another computer device, said multiplicity of outputs to determine the substantially best objective function value and the arrangement of energy conduits associated therewith.

By using a non-deterministic mixed integer non-linear programming algorithm to estimate an optimised arrangement of energy conduits in an array as a non-linear problem by running the algorithm a multiplicity of times using substantially the same problem definition and the same stopping criteria but with different seeds, the advantage is provided that a multiplicity of computing devices used in parallel allows the estimated optimisation to be produced more quickly and accurately (using more complex and accurate problem definitions) than using methods of the prior art. Typically, where similar problems are solved using non-deterministic optimisation algorithms in the prior art, a single run of the algorithm is used using a single computing device and running for a long period of time. This long runtime is used to ensure that there is a high likelihood that a close to optimum output (the objective function value) has been found. However, it has been discovered that it is more effective to run the algorithm many times for a significantly shorter period of time and then determine which objective function value has provided the best lifetime value return on the proposed arrangement of energy conduits.

It is also the case that in the present invention, the computing effort is used more effectively. That is, for the same amount of computing effort there is typically an increased reliability of returning good results and/or reduced variability in the results returned. In other words, running more computers for less time, and in particular using an algorithm that has less compromises or simplifications such as a mixed integer non-linear programming algorithm, gets a result that has a higher lifetime value (is closer to the true optimum) than systems of the prior art.

Furthermore, by running the same algorithm repeatedly for a short period of time, the algorithm can be run on a multiplicity of computing devices. This disaggregates the waiting time from the calculation time, meaning that more computing power/effort can be reasonably deployed resulting in better results. In addition, this enables reduced waiting time which gives users productivity gains and thus they can run more scenarios of different input data where appropriate. This results in reduced lead times and reduced engineer hours required to complete the design process. This is in part due to increased confidence in the results produced by the algorithm and the reduced time allowing more variations (such as substation locations) to be tried within the time constraints of a design process.

In examples of the prior art, it is the case that the objective function part of the algorithm is executed many times on each iteration within the algorithm, the time taken to execute the cost model is important and, as a result, it is often the case that simplifications in the definition of the problem are made to ensure a reasonable calculation time. For example, the more complex non-linear problems are addressed by simplifying the algorithm to include only linear functions which act as an estimation of the non-linear problem. However, this risks that the model is optimising away from the true optimum.

Sometimes parallelisation is used in the prior art within the calculation of the objective function execution to resolve some of these issues. However, the key difference is that in the prior art every iteration is dependent on the result of the previous iteration and the parallelisation happens within the objective function execution of the iteration. Whereas in the present invention we are performing independent calculations of the algorithm itself in parallel including all of its iterations, so one computer's iteration is not dependent on any other computer's iteration. The method of the present invention makes more sophisticated cost models feasible in particular those including mixed integer non-linear problems. This allows one to wait for the optimisation to be completed, which in turn results in optimisation towards more accurate models of the real world possible.

Because, in the present invention, the real world time taken for completing an optimisation task is significantly less than the prior art, time-critical optimisation problems (such as those related to the emergency services for example allocation of rescue resources in a search and rescue) can now be solved in typically seconds to minutes rather than typically hours to days. It is also possible to use this rapid optimisation to undertake multiple levels of optimisation related to one project. For example, in an inter-array cable system for an offshore wind farm, there are multiple factors relevant to the overall capital costs. These include the arrangement of cables but also the position of any substations within the array. It is therefore possible to undertake multiple rounds of optimisation for these different features.

In Fischetto Martina et al, the method disclosed therein uses a mixed integer linear programming algorithm to address the problem of cable optimisation. This is achieved by isolating a small part of the network and optimising that small bit while keeping the rest constant, then isolating a different part and repeating many times. Although the problem of power losses is a non-linear problem, the system in Fischetto Martina et al, addresses this by estimating the power losses as a linear term in the algorithm and optimising using mixed integer linear programming (MILP). The compromise of estimating the power losses into a linear term to allow the optimisation to be run as MILP reduces the likelihood that the optimised array that has been found by the algorithm is close to the true optimum. That is, linearising the power losses means the cost model in this prior art is a less accurate model of the real inter-array cable system, meaning that the optimum in the prior art formulation is less likely to match up with the real world optimum. The MILP algorithm finds the global optimum (that is the optimum for the algorithm) but this might not be close to the true (real world) optimum for the array due to the compromises of linearising non-linear terms.

It should be pointed out that it is counterintuitive to run a more complex (non-linear) algorithm for less time if you are looking to get closer to a true real-world optimum. However, running the complex algorithm for a short run time a large number of times produces an output that is closer to the true optimum than is seen in the prior art. This is in part because the optimums that are found by each calculation are dependent on the quality of the seed that is the starting point and the ease of the journey to reach the calculated optimum. By running a statistically significant number of calculations from different seeds resulting in different journeys through the calculation space the system of the present invention is more likely to end up with a result that is close to the real world optimum in particular because more complex (closer to real world) algorithms can be used. The minimum statistically significant sample size is highly dependent on the problem formulation, the results one plans to obtain, and the predictions one plans to make. Hence, the minimum sample size to qualify as statistically significant should be determined by a qualified statistician using methods such as goodness of fit tests (e.g. Kolmogorov Smirnov, Anderson Darling), one and two sample t-tests, statistical power analysis, and statistical significance analysis. The preceding examples are a non-exhaustive list of suitable techniques and others are available which may be selected at the discretion of the person skilled in the art.

In a preferred embodiment the at least one mixed integer non-linear programming algorithm comprises optimising for energy lost in said energy conduit.

Because energy losses are one example of a non-linear problem associated with cable array optimisation, using a mixed integer non-linear programming algorithm as described above allows for a more accurate optimisation, that is an optimisation that is nearer to the true optimum, than the estimations used in the prior art. In particular, creating a linear term to model energy losses, which are nonlinear in reality, in a mixed integer linear programming algorithm is a less accurate method of optimisation.

The method may further comprise analysing said multiplicity of objective function values to obtain at least one of a probability distribution function of the objective function values; probability distribution function of a calculation time of the chosen algorithm; summary statistics of the objective function values; and summary statistics of the calculation time.

The method may also further comprise using said probability distribution function or summary statistics of the objective function values to estimate probabilistic bounds of the substantially best objective function value.

Using probability distribution function or summary statistics such as the mean, percentile values, median, minimum, maximum, standard deviation and variance metrics provides additional advantages over the prior art. Since each of the calculations are independent, a statistical distribution can be generated enabling an estimation of ‘how lucky’ one has been compared to what could happen if one were to run the algorithm again. As a result, it can be determined whether the objective function value returned at the end of the study was sufficiently lucky or whether it is warranted to rerun the study in the hope of better results.

Furthermore, the constructed probability distribution can be used to inform exactly how many more calculations are needed to have a desired chance of beating a certain percentile of the distribution of objective function values. Hence, the exact amount of computing resources can be used to obtain the desired result, avoiding wasted time and costs. By quantifying the probability of improvement, the inherent uncertainty in the optimality of the heuristic algorithm result is mitigated. It follows that this can be incorporated within the algorithm itself as a stopping criterion, automatically stopping the multiplicity of calculations once a desired percentile, or ‘degree of luck’, has been reached.

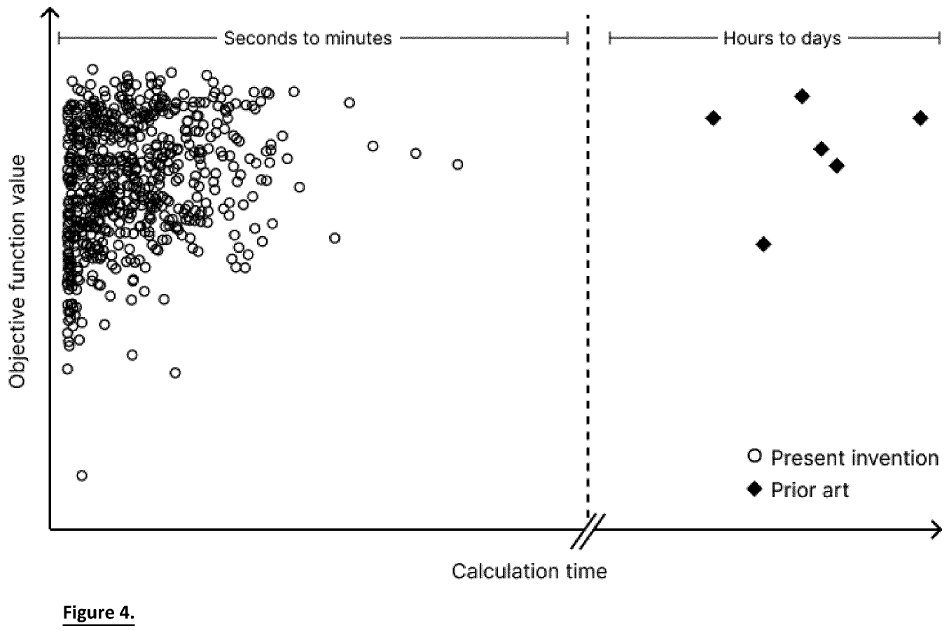

A corollary benefit from this is that the obtained probability distribution is far more robust to random chance than simply taking the best result found during the study. This means a change made to the model inputs can be more confidently linked to the subsequent change in the best achievable solution using those inputs. This is further illustrated below with reference to FIG. 4 of the drawings.

The method may further comprise, prior to undertaking the method for estimating an optimum arrangement of energy conduits in an array set out above:
performing the analysing steps of the method set out above in a plurality of studies, each study using different stopping criteria;
using at least one said distribution function to predict probabilistic bounds at different numbers of calculations to estimate a best balance of number of calculations and stopping criteria to efficiently estimate an optimum arrangement of energy conduits in an array; and
running a further study according to any of the preceding claims to estimate an optimum arrangement of energy conduits in an array with said best balance of number of calculations and stopping criteria.

In a preferred embodiment at least one empirical relationship is determined between said stopping criteria and said distribution functions and/or said summary statistics.

By performing a series of pre-study calculations, the advantage is provided that the results of these calculations allow an estimation of the probabilistic bounds of the objective function value for any stopping criteria and any number of calculations. This then allows a determination of the most appropriate stopping criteria and number of calculations prior to undertaking the study to estimate an optimum arrangement of energy conduits in an array.

In a preferred embodiment the objective function value is determined including at least one of:
the cost of the energy conduit;
the energy lost in said energy conduit;
the cost to maintain the energy conduit;
the cost to repair the energy conduit;
the energy lost due to power losses in the energy conduit;
the energy lost due to outages;
the amount of energy reaching a given point in the array or energy conduits;
the value of energy passing along the energy conduits; and
the cost of installing said energy conduit.

In a further preferred embodiment the multiplicity of outputs are used to produce a heatmap of arrangements to provide said estimated optimum arrangement.

By having an output in the form of a heatmap, it is possible to give reasonable estimates of highly likely positions for components (for example cables or substations) so that initial survey work can be undertaken to establish the suitability of the proposed site before further optimisation work is undertaken. In the prior art attempts to perform a similar study would result in an unfeasible time to perform the calculations required to generate the heatmap. In the case of the substation, the heatmap is used to create a recommended location for the substation that is most likely to produce lowest overall cost of the cable inter-array.

In a preferred embodiment the energy conduits comprise cables.

In another preferred embodiment the cables connect a plurality of energy generation devices to at least one node.

In a further preferred embodiment the energy generation devices comprise wind turbines.

According to another aspect of the present invention there is provided a method of installing an array of interconnected energy related apparatus, comprising the steps:
determining the locations of an array of energy related apparatus;
using a method as set out above to estimate an optimum arrangement of energy conduits interconnecting said array; and
installing said energy related apparatus and said arrangement of energy conduits.

In a preferred embodiment the energy conduits comprise cables.

In another preferred embodiment the energy related devises comprise energy generation devices.

In a further preferred embodiment the energy generation devices comprise wind turbines.

In another preferred embodiment the stopping criteria results in an average runtime for a single run of the algorithm of less than 60 minutes or less than 30 minutes or less than 15 minutes or less than 10 minutes.

In a further preferred embodiment the multiplicity of computers comprises at least 10 computers or at least 25 computers or at least 32 computers or at least 50 computers or at least 100 computers or at least 1000 computers.

According to a further aspect of the present invention there is provided a method for estimating a solution to a non-deterministic problem, comprising the steps:
setting up, on at least one computer device, a non-deterministic mixed integer non-linear programming algorithm to optimise a non-linear optimisation problem, the algorithm producing an output including an example solution to the problem and an associated objective function value;
performing, on said at least one computer device, a calculation of said algorithm a multiplicity of times, in parallel, to produce a multiplicity of outputs using substantially the same problem definition, using substantially the same stopping criteria and using different seeds; and
analysing, on a said or another computer device, said multiplicity of outputs to determine the substantially best objective function value and the example solution associated therewith.

The present invention provides the advantages set out above. In addition, it is suitable for providing an estimated solution to non-linear optimisation problems beyond those of cable position in an inter-array offering some or all of the advantages set out above. For example, the present invention gives sufficient confidence in an optimisation that contains non-linear functions to allow quick decisions to be made where previously optimisation would not have been used due to the long time required to complete an optimisation. As a result, such optimisations including non-linear functions can be used in emergency situations such as the allocation of rescue resources in a search and rescue. Furthermore, regularly scheduled complex problems with a short turnaround time, such as the selection of delivery routes, can be optimised quickly with a high degree of confidence that the suggested route is close to the true optimum.

The method may further comprise analysing said multiplicity of objective function values to obtain at least one of a probability distribution function of the objective function values; probability distribution function of a calculation time of the chosen algorithm; summary statistics of the objective function values; and summary statistics of the calculation time.

The method may further comprise using said probability distribution function or summary statistics of the objective function values to estimate probabilistic bounds of the substantially best objective function value.

The method may further comprise, prior to undertaking the method for estimating a solution to a non-deterministic problem set out above:
performing the analysis steps set out above in a plurality of studies, each study using different stopping criteria;
using at least one said distribution function to predict probabilistic bounds at different numbers of calculations to estimate a best balance of number of calculations and stopping criteria to efficiently estimate an optimum example solution to the problem; and
running a further study according to any of the preceding claims to estimate an optimum example solution to the problem with said best balance of number of calculations and stopping criteria.

In a preferred embodiment at least one empirical relationship is determined between said stopping criteria and said distribution functions and/or said summary statistics.

In another preferred embodiment the stopping criteria results in an average runtime for a single run of the algorithm of less than 60 minutes or less than 30 minutes or less than 15 minutes or less than 10 minutes.

In a further preferred embodiment the multiplicity of computers comprises at least 10 computers or at least 25 computers or at least 32 computers or at least 50 computers or at least 100 computers or at least 1000 computers.

Preferred embodiments of the present invention will now be described, by way of example only, and not in any limitative sense with reference to the accompanying drawings in which:-

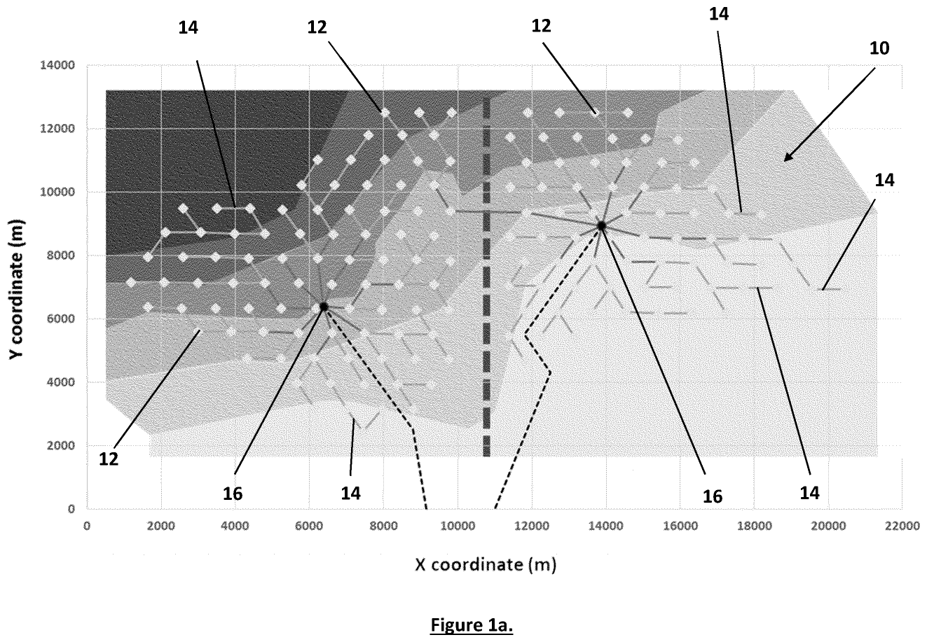

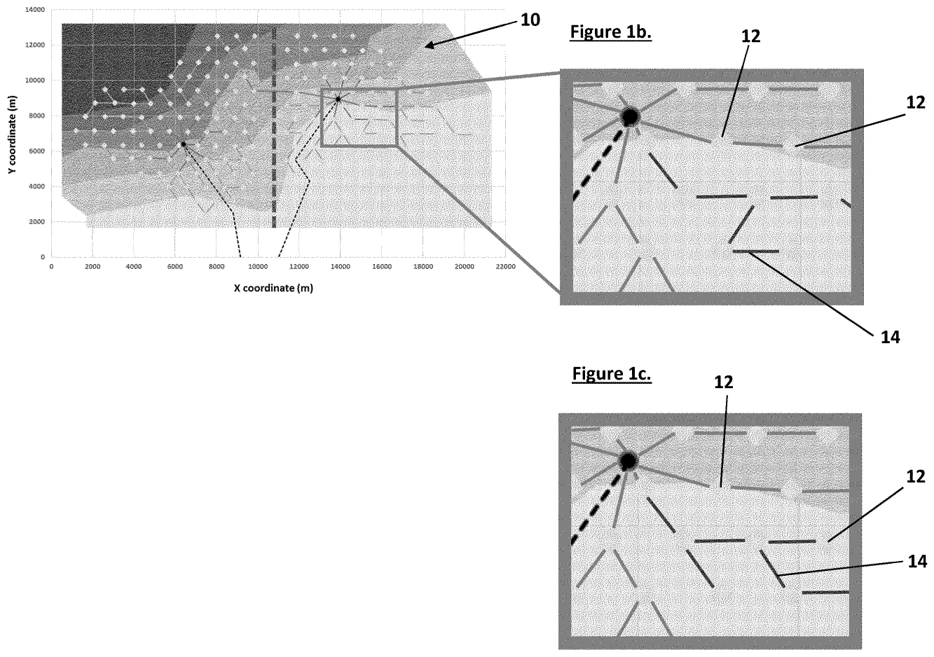

FIG. 1a is a schematic representation of an offshore wind farm layout;

FIGS. 1b and 1c are a pair of close up views of the layout of FIG. 1a;

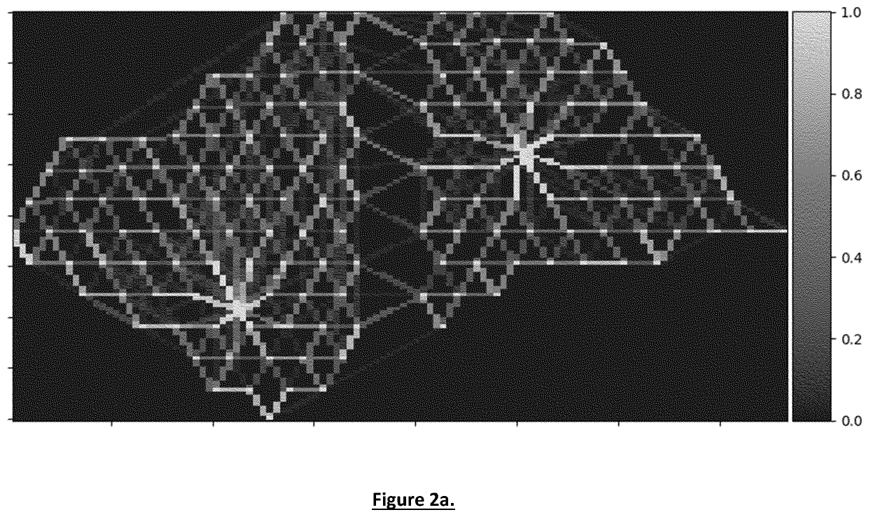

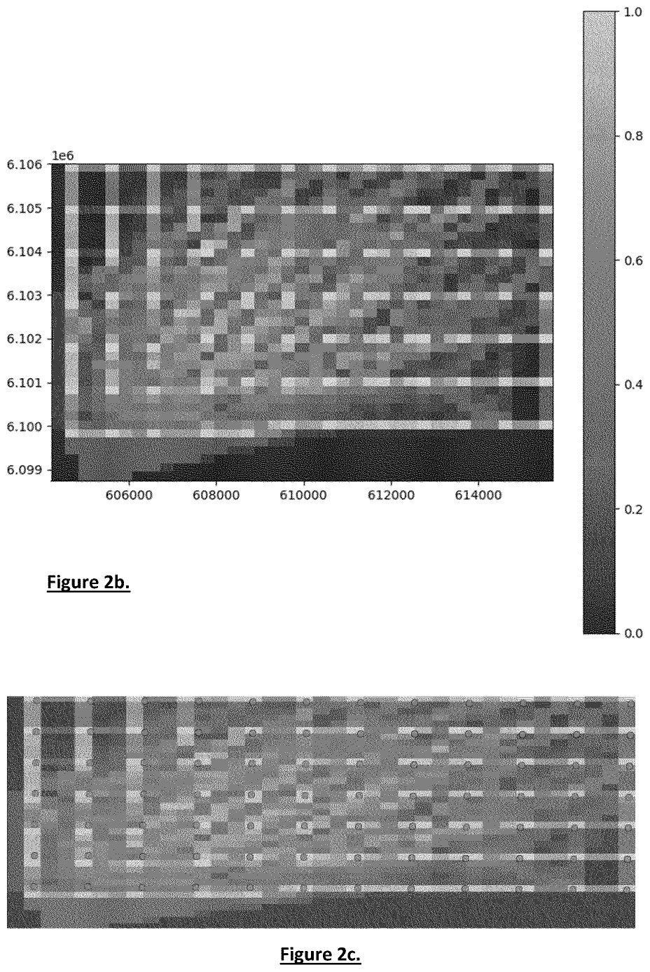

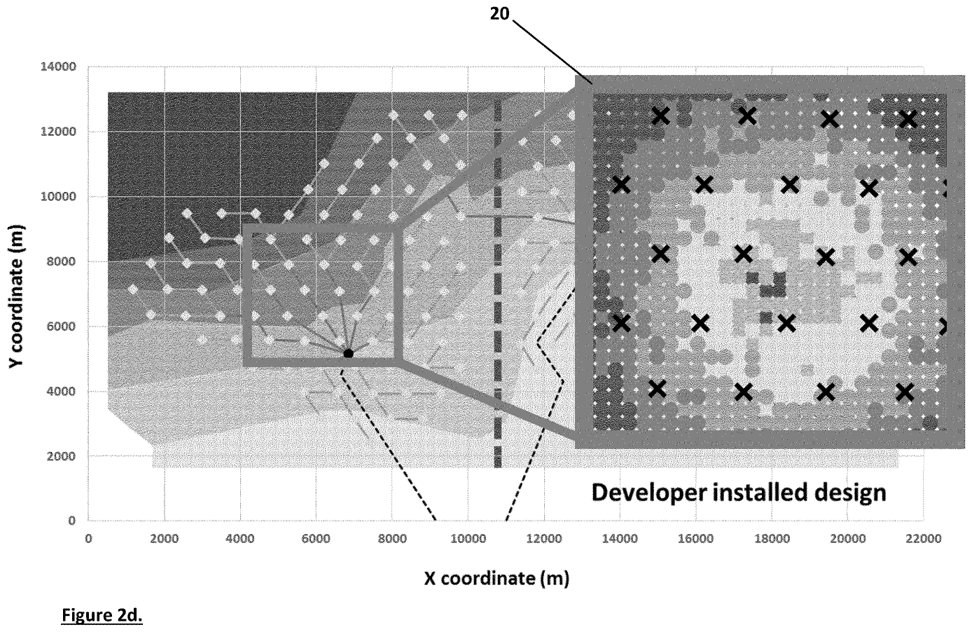

FIGS. 2a, 2b, 2c and 2d are examples of heat maps illustrating outputs used in the present invention;

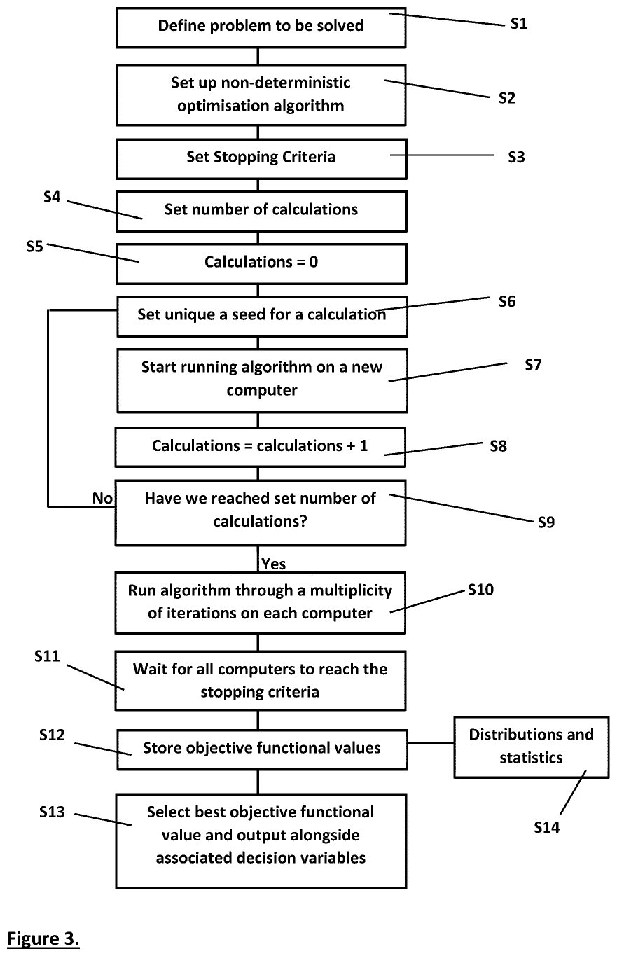

FIG. 3 is a flow chart representation of the process of the present invention;

FIGS. 4, 5 and 6 are graphs illustrating key benefits over the prior art.

The method of the present invention is used to estimate the optimum arrangement of energy conduits in an array. An example of where the present invention is used is in determining the optimum arrangement of inter-array cables in an offshore wind farm which consists of an array of electricity generating wind turbines. Referring to FIG. 1a, the schematic representation of a wind farm 10 illustrated has multiple energy related apparatus in the form of turbines represented by the dots 12 which are connected to adjacent turbines by energy conduits in the form of cables which are represented by the lines 14. FIGS. 1b and 1c illustrate two of the many possible arrangements of cables to connect the turbines. The multiple turbines are connected to localised substations or nodes 16 which accumulate the generated electricity together before the transfer to shore occurs. The node 16 (substation) is commonly but not exclusively located offshore, with an export cable connecting the offshore node(s) to an onshore substation for wider transmission of electricity to where the energy is utilised. The cables can, in principle, connect each turbine directly to a node. However, in practice this is not done and connections run from one turbine to an adjacent turbine and so on before final connection to the node.

The cables between the turbines must be capable of delivering the electricity generated by each turbine. Bearing in mind the high wattage which can be produced by a turbine, the cost of these connecting cables is significant per unit length. Where one turbine is connected to another, the cable from the second turbine (closer to the substation) carries the electricity from both turbines requiring a larger and therefore potentially more expensive cable to be used. Since power losses in cables are inevitable, it is also an important factor in determining the optimum arrangement of cables and ensuring that the selected arrangement, in minimising those losses, is balanced against the capital, installation and operational costs. These power losses are one example of a non-linear factor which results in the optimisation of a cable array being a non-linear problem which is best addressed using a mixed integer non-linear programming algorithm. As a result, it can be seen that there are potentially competing factors in determining the optimum arrangement of cable. Savings can be made in capital and installation costs by producing an optimised arrangement of cables which minimises total cable cost. In addition, improvements can be made in the efficiency of power transfer from the turbines to the nodes, prior to transfer onshore. These factors, together with others, provide a so-called lifetime value for a particular arrangement of cables between turbines and nodes. The purpose of the present invention is to determine the best estimate for the optimum arrangement of cables so as to provide the maximum lifetime value or similar life cycle cost metric, that is the best return on the investment being made in the windfarm. This lifetime value is therefore an objective function value of the algorithm used to estimate an optimum arrangement of cables in the array.

The problem to be solved in estimating the optimum arrangement of cables in an array of electricity generating wind turbines in an offshore windfarm is a non-linear mixed integer problem and a solution is sought using a non-deterministic optimisation algorithm, more specifically a mixed integer non-linear programming (MINLP) algorithm. The outputs of the algorithm include an arrangement of energy conduits in an array and an associated objective function value that is associated with that arrangement.

First, we must define the problem. The problem definition includes defining the objective function, identifying the decision variables which are to be optimised and identifying any fixed input variables, and defining any constraints which must be adhered to within any acceptable solution. That objective function value (which can also be called, dependent on the problem being solved, a fitness value, cost function value or lifetime value) is a numeric value associated with the output array that represents the benefit gained by that arrangement. Next, the definition of the problem is determined which includes defining the problem. Example factors used in the definition of the problem include, but are not limited to, proposed positions of the turbines, maximum output of the turbines, the positions of the nodes/substation, the types and capacity of cables used to connect the turbines, sea bed terrain and features which the route of the cable passes, and the location of a substation to onshore cable. Constraints must also be defined and these include, but are not limited to, the maximum number of turbines connected in a string from the collection node, the maximum number of strings (cables) that can connect to the collection node (turbine or substation), cables being required to avoid certain areas and whether cables are permitted to cross over each other.

The stopping criteria for running the algorithm is also defined. Details of how the stopping criteria is selected are set out below.

Finally, once all of the input and other variables have been decided, a suitable non-deterministic optimisation algorithm can be defined or selected to address that optimisation problem. Examples of suitable non-deterministic optimisation algorithms include, but are not limited to, a tabu search algorithm, a simulated annealing algorithm, a genetic algorithm, an ant colony optimisation algorithm, a particle swarm optimisation algorithm, an artificial fish swarm algorithm, an artificial bee colony algorithm, a greedy randomised adaptive search procedure algorithm, a large neighbourhood search algorithm, an artificial neural network algorithm, and the like. Where factors which results in non-linear problems being defined, such as including power losses in the cables, a non-deterministic mixed integer non-linear programming algorithm is used to undertake the optimisation.

Once the algorithm is set up a study is undertaken and the output of the study is, for example, an optimum arrangement of cables and/or the associated objective function value. The study is made up from a multiplicity of calculations with each calculation being a run of the selected non-deterministic optimisation algorithm through a multiplicity of iterations until a stopping criteria is reached. When a study is undertaken using the non-deterministic optimisation algorithm, an output of each calculation is the objective function value. This objective function value is an evaluation of the arrangement of cables and considers a combination of factors. These factors include, but are not limited to, the cost of cables per unit length of the different sizes of cables, the cost of laying the different cables per unit length, the likely power losses over the lifetime of the cable with the associated cost and the rate of degradation of the cable. Other factors include, but are not limited to: the cost of installing connections between turbines; the cost of laying cables per unit length; the cost to maintain the energy conduit; the cost to repair the energy conduit; the energy lost due to power losses in the energy conduit; the energy lost due to outages; the amount of energy reaching a given point in the array or energy conduits; the value of energy passing along the energy conduits; and the cost of installing said energy conduit.

Compared to systems of the prior art that use non-deterministic optimisation algorithms to solve the non-linear mixed integer problem of estimating an optimum cable arrangement in an array of wind turbines, the algorithm in the present invention is run and rerun a multiplicity of times, ideally utilising parallel processing in multiple computer devices, but is stopped after a short period of time, whereas systems of the prior art run the algorithm once for a long time. In each calculation, substantially the same starting variables are used and therefore, in each case the same problem is defined. The algorithm is run through a calculation using the same stopping criteria but, in each case, a different seed is used. Using a different seed for each calculation enables the non-deterministic optimisation algorithm to potentially take a different path through the solution space to arrive at potentially different equally valid solution at the point of reaching the stopping criterion.

As previously stated, it is counterintuitive to run a more complex (non-linear) algorithm for less time if you are looking to get closer to a true real-world optimum. Examples of calculation time that are suitable include, but are not limited to, less than 60 minutes. Preferably less than 30 minutes. More preferably less than 15 minutes. Even more preferably less than 10 minutes.

Likewise, the number of computers that run the algorithm should exceed 10. Preferably 25 to 32 computers should be used to ensure that the results are statistically significant. More preferably 50 computers should be used. Even more preferably 100 computers should be used. Ideally 1000 or more computers should be used. It is important, although not essential that the number of computers used provides a statistically significant result.

In more detail, this means that each calculation starts with a different initial arrangement of the cables in the array. The seed is a randomly generated number, or a number in a known sequence of random numbers, that facilitates, or seeds, the random propagation of the cables in the starting point arrangement of the array at the beginning of each calculation. That arrangement of cables is then randomly modified, which is also governed by the seed, by changing the positions of one or more cables. Normally when the position of a cable is moved there are consequential movements of other cables to maintain the array connecting all of the turbines and ensuring a feasible solution that does not violate any of the constraints identified in the problem definition. This new arrangement is the result of one iteration of the selected non-deterministic optimisation algorithm and is tested to determine the objective function value. As an example of a very simple version, the objective function value might be the total cost of cable used assuming only a single type of cable connects all the turbines. The total length can be converted into a cost. If the total cost of the cable required after the iteration of the algorithm is less than the previous arrangement then this arrangement is better (less expensive) giving a better objective function value.

However, because the arrays link turbines in series, it is beneficial to use cables with lower capacities between the turbines at the ends of a string whereas when more turbines have been joined, the capacity of the cables must be greater. This is known as tapering as the cables become thinner towards the end of a string. It is possible using the method of the present invention to determine how much cable of each different capacity is required and the total cost calculated. This alternative objective function value provides more useful information than the simplest version previously described. Further factors are added, during the definition of the problem, to create an objective function value which reflects the lifetime cost, the total cost over the lifetime of the windfarm, of a proposed array.

The objective function value of the new arrangement of cables in the array is compared to the objective function value of the previous arrangement and if that new arrangement does not offer a better objective function value then the new arrangement is discarded. However, if the objective function value of the new arrangement is better, it is kept and used as the starting point for the next iteration. The process repeats through the iterations until the stopping criteria is reached. Once the stopping criteria has been reached (the end of a calculation) the objective function value for that calculation is stored along with the final (most improved) arrangement of cables in the array. In the example described above, the optimisation algorithm is seeking the inter-array offering the best objective function value. The best objective function can be the lowest value output, for example, the cost of cable, cost of installation, or energy losses. Equally, the best objective function value can be the highest output, for example, the value of energy received onshore after losses and capital expenditure have been accounted for, revenue or energy received at a substation or availability of power onshore or at a substation.

A second calculation is undertaken, typically in parallel to the first calculation, using a new seed (starting arrangement of cables in the array) using the process set out above. When the stopping criteria for this second calculation is reached (at approximately the same time as for the first calculation) the final objective function value for the new calculation is compared to the final objective function value for the first calculation and the better result (better objective function value) is kept. Because there are a multiplicity of calculations taking place in parallel (not just two) the comparisons between all the objective function values takes place at one time.

As an alternative to the seed determining a new starting arrangement of cables in each calculation, the same starting arrangement of cables can be used each time but the difference (the seed) is the changing of which first cable is moved to an alternative position. Although this method works to produce a similar result to that described above, this version has the disadvantage that the result may not be as good or it might take longer (more calculations and therefore more computer time) to get to a satisfactory result. If the first arrangement of cables chosen is a long way from being the optimum solution, the results of each calculation may not be as good as if new arrangements are used each time. There is also a problem that all the calculations may get stuck in the same local minima within a graph of improved objective function value against iterations triggering the stopping criteria before the optimisation has truly been reached.

The stopping criteria determines how long the algorithm runs for and a stopping criteria is selected that reduces significantly the time that each run takes compared to a single run system of the prior art. An example of a suitable stopping criteria is to select a number of iterations that the algorithm is run for before the calculation is stopped. Since the same stopping criteria are being used for each run of the algorithm, if the number of iterations is the stopping criteria, then the algorithm is run for substantially the same number of iterations each time. Alternative stopping criteria include, but are not limited to: a set number of iterations since the last improvement in the objective function value; an allocated budget (of computational time/cost) has been reached; until there is no improvement, or no improvement beyond a certain tolerance, in the whole population (or the top N individuals in the population) over a certain number of iterations; until there is no significant change in surviving individuals' decision variables (that is, changes that could be below achievable real world resolution) over certain number of iterations or combinations of these.

The study is most efficiently undertaken by running the calculations on a multiplicity of computer devices running in parallel. Therefore, each of the different seeds, the initial starting point arrangement of cables in the array, is programmed into a different machine and these computers run through their respective calculations at substantially the same time thereby producing their respective outputs also at roughly the same time. More specifically, the seed is normally a randomly generated number, or a number in a known sequence of random numbers, that facilitates the random propagation of the cables throughout each calculation.

Once the multiplicity of runs have been completed, the outputs are coordinated together and analysed to determine the best objective function value and the arrangement of cables that leads to this best result is then used since it provides the best return on the investment in installation of cables. In its simplest form, this is using the arrangement of cables which gives the highest objective function value.

With an optimum arrangement of cables determined (or estimated) the process of building the windfarm is undertaken by placing turbines in the specified locations and then connecting them together with the specified cable types to join to a substation which is linked to a to-shore delivery cable.

It is, under the majority of circumstances, advantageous to undertake some preliminary calculations prior to running a study in order to help determine the number of calculations and stopping criteria that best balances the computer time used to perform the study against the quality of the results obtained. In particular, multiple studies are undertaken and analysed using the objective function values to work out at least one of a probability distribution function of the objective function values; probability distribution function of the calculation time of the chosen algorithm; summary statistics of the objective function values; and summary statistics of the calculation time. Those probability distribution functions and/or summary statistics are then used to estimate probabilistic bounds of the substantially best objective function value. The probabilistic bounds are then used at different numbers of calculations to estimate the best balance of the number of calculations and stopping criteria to effectively estimate an optimum arrangement of energy conduits in an array. That is, the probabilistic bounds are used to determine the empirical relationship between the stopping criteria and the distribution function or summary statistics allowing a decision to be made (by an operator or via automated logic) as to the most suitable balance between the number of calculations (which cumulatively equates to the total computer time) and the stopping criteria selected which is also a factor in the time each computer operates for to complete its calculation.

FIGS. 2a, 2b, 2c and 2d are examples of heatmap outputs from the method of the present invention which can be used as part of the process of planning an inter-array of cables in an offshore windfarm. In FIG. 2a, a study to determine the optimum arrangement for the array of cables has been run through a multiplicity of calculations and the arrangement found at the end of each study used to create a heatmap. Where each study may or may not have different input data for values that are uncertain, for example substation location. In that heat map, the lighter colours show the locations where connections between turbines are most commonly present at the end of the calculations with the darker colours showing the least commonly present. This data can then be interpreted to indicate that it is most likely that a connection will be required where light colours are present and it is therefore worth considering undertaking early stage seabed surveying in this area as part of the process of gathering data which is then used in the final problem definition. Furthermore, the map gives examples of locations that are least likely to have cables between turbines and therefore is used to identify likely possible routes for the cable linking the substation to the shore. It is generally not desirable to have cables crossing one another and the heatmap of FIG. 2a can be used to determine a route for the to-shore cable that is unlikely to have inter-turbine cables crossing it, that is, to reduce the likely constraint of the export system when undertaking an inter array cable layout optimisation that considers the export route.

In FIGS. 2b and 2c, an inter array of cables for a different location is shown. In this example more calculations are included in the study although the scale used is different resulting in pixels each representing a larger area of seabed. In FIG. 2c the positions of the turbines are indicated with the circles. As with FIG. 2a, the lighter colours represent an increased likelihood of a cable being present on the seabed represented by those pixels. The scale (in FIG. 2b) shows that likelihood as a probability.

In FIG. 2d a preferred location for the substation 16 is being determined. In this example, a study is run for a given substation location and this returns a cable layout and the objective function value of that cable layout. A further study is then run but with the substation location moved and this returns another cable layout and the lifetime value of that cable layout. This process is further repeated for many studies each with a different substation location, each study returns a cable layout and the lifetime value of that cable layout. The portion of FIG. 2d labelled 20 shows the position of each substation represented by a circle. The colour (or shade in the black and white figures) of the circle represents the (relative) lifetime value of the optimal cable layout associated with that substation location. For example, the darker dots towards the centre of that portion 20 of the image indicate that placing the substation at that coordinate and running a study returns a cable layout with a lower cost or better lifetime value compared to other locations considered. From this the darkest shaded locations in the centre of the image represent the most promising location for the substation. This can be fixed and studies then conducted to determine the optimum cable layout for this optimum substation position.

With additional reference to FIG. 3, the method of the present invention will now be described. The first stage of the method of the present invention is to define the problem to be solved (step S1). Defining the problem includes defining objective function, the decision variables and any constraints. This includes defining, for example, the fixed parameters such as the turbine positions, the position of substations and the to-shore cable route if these have been decided and are not part of the study being undertaken. At step S2, the non-deterministic optimisation algorithm is selected or defined and set up. Next, at step S3, the stopping criteria for each calculation is set. The total number of calculations that will be undertaken within the study is also set (step S4) and the calculations count variable is set to zero (step S5).

Then the seed is set for the first calculation at step S6. The present invention is most efficiently run using one or more servers comprising a plurality or multiplicity of processors each running a calculation. That group of computers should ideally include a statistically significant number of processors running the algorithm. That statistical significance typically starts at 25 to 32 computers although more (50, 100, 1000 or more) are preferable. Also, a smaller number, say 10, may also produce a useful result. At step S7, a computer (a processor within the server) starts running through the iterations of a calculation. The calculation count variable is increased by one (step S8) and a check to see if sufficient calculations have been started by checking if the calculation count variable has reached the total calculation required (step S9). If more calculations are needed the process loops back through steps S6 to S9 starting more processors running more calculations each with a new seed until the total required calculations have been started.

With all the computers running the algorithm through a multiplicity of iterations (step S10) it is then necessary to wait for all of the computers to reach the stopping criteria (step S11) and store the objective function values resulting from each calculation (step S12), together with their associated cable layout. The best objective function value from all of the calculations is selected and output, along with the associated decision variables, that is, the best result which is then recommended as the best estimate of the optimum layout for the cables in the inter-array.

Optionally, at step S14, analysis of the objective function values, and the stopping criteria and number of calculations that led to those values, can be undertaken to gain additional information about the study and the quality of results obtained. For example, a probability distribution function and/or summary statistics of the objective function values can be calculated. Similarly, a probability distribution function and/or summary statistics of the calculation time can be determined. Examples of the summary statistics include, but are not limited to, the mean, any percentile value, the median, the minimum and/or maximum value, the standard deviation and variance metrics. Because each calculation in the study is independent, the statistical distribution so generated enables an estimation of ‘how lucky’ one has been compared to what could happen if one were to run the algorithm again. As a result, it can be determined whether the objective function value returned at the end of the study was sufficiently lucky or whether the study should be extended by performing further calculations. It also means that if one was to change input data and see its impact on the optimised result, the probabilistic bounds could be used instead of the best objective function value found in isolation, enabling relationships to be determined without the impact of the stochastic nature of the algorithm causing uncertainty in the results.

A corollary benefit from this is illustrated in FIG. 4 by comparing two examples of results obtained using systems of the prior art (for example Fischetto Martina et al) shown using the circles with two sets of results for the present invention shown using the bell-curve lines. The choice of input parameters heavily influences the achievable optimal solution. When comparing two sets of inputs, A (dashed) and B (solid), the prior art blindly samples individual optimised objective function values from the solution space as shown by the circles in FIG. 4. However, the present invention obtains probabilistic bounds on the best reasonably achievable objective function value, as previously mentioned due to the high number of calculations undertaken. In the scenario shown in FIG. 4 the prior art method was, unknowingly, unlucky when using input set B, while a single calculation got very lucky when using input set A. That is, the objective function value of the Prior art B sample (solid circle) is, by chance, higher than the objective function value of Prior art A sample (dashed circle). Here, using the method of the prior art a user would conclude that input set A is optimal as it obtained the highest objective function value after repeat calculations. The present invention however would correctly conclude that input set B is optimal as it has greater potential to achieve a more optimal objective function value. This holds even if the best individual calculation using input set A outperformed all calculations using input set B, hence improving on simply running repeats of the prior art method and taking the best solution.

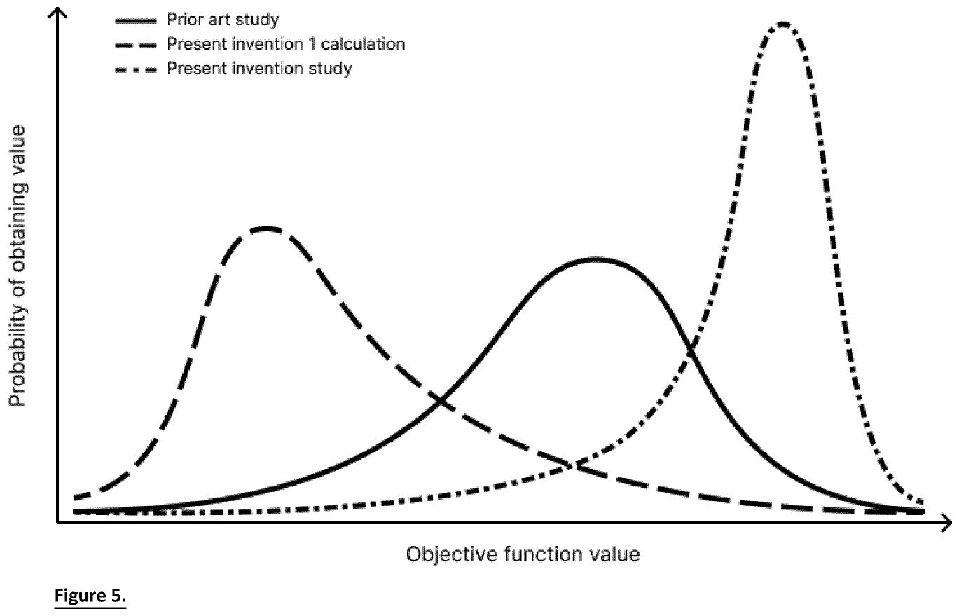

FIG. 5 shows the result of a typical present invention study compared to a prior art study. The prior art employs longer calculation times as the main method of achieving higher lifetime value. Several embodiments of the prior art acknowledge the impact of the initial starting point of the optimisation. When acknowledged, the prior art typically aims to avoid the effect of a particularly unlucky seed yielding an uncharacteristically poor solution by performing several restarts. On the other hand, the present invention aims to actively exploit this phenomenon by performing a much larger number of restarts, aiming to get a particularly lucky seed which achieves a very high objective function value in very little time. For example, if the prior art were to run a single calculation for 1 hour, the present invention may favour running 60 calculations for 1 minute each. In this example both methods use the same computational resource but the restarts in the present invention can be run in parallel, disaggregating objective function value from calculation time. This enables use of more complex objective functions which can be more representative of the real world problem. This leads to the counterintuitive benefit that we can solve a more complex formulation of the problem by reducing the calculation time.

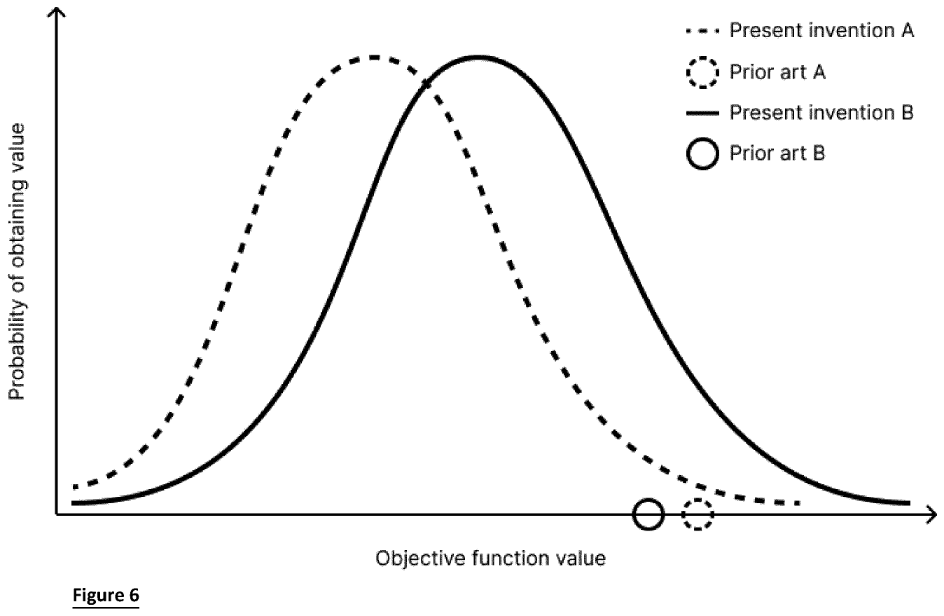

In addition to enabling use of more complex objective functions, repeat studies using the present invention yields a tighter range of objective function values, centred more towards higher values, as shown in FIG. 6. The solid line in FIG. 6 (Prior art study) is a probability distribution representing the results one would expect to obtain when running repeat studies using the prior art. Running for a long optimisation time means there is less likelihood of very low objective function values, so the distribution is skewed to the right. The dashed line is representing single calculations within the present invention study (Present invention 1 calculation). As previously mentioned, the individual calculations are run for a very short length of time, meaning the range of objective function values one would expect them to return individually is skewed towards lower values. However, a study in the present invention consists of a multiplicity of short studies. As previously mentioned with reference to FIG. 5, dividing the computation resource into many restarts rather than a few long optimisations not only saves time by allowing parallelisation, but is also more likely to achieve a better solution with the same computational resource. Additionally, due to the law of large numbers, each study using the present invention will more consistently achieve a high percentile in the distribution of objective function values. All of this results in a tighter range of expected objective function values which is skewed further to the right as shown by the dash-dot line in FIG. 6 (Present invention study).

These analysis steps can also be used in a pre-study study which helps determine what is a suitable balance between number of calculations to be undertaken and the stopping criteria that should be selected. A plurality of studies, each with a multiplicity of calculations but typically less than for the full study, are undertaken with each study using a different stopping criteria. Then, distribution functions are determined for the stopping criteria. These are then used to estimate a best balance of number of calculations and stopping criteria by determining the empirical relationship between the stopping criteria and the number of calculations to then efficiently estimate an optimum arrangement of energy conduits in an array. Once the effective balance of number of calculations and stopping criteria has been determined, the study to determine the optimised array is run using this number of calculations and stopping criteria.

It will be appreciated by persons skilled in the art that the above embodiments have been described by way of example only and not in any limitative sense, and that various alterations and modifications are possible without departure from the scope of the protection which is defined by the appended claims. For example, the embodiments set out above should not be read a separate disclosures of independently operating inventions. In particular, where various embodiments and aspects of the invention have been described above, features and steps of the apparatus and method are interchangeable between the embodiments and aspects of the invention. For example, where dimensions and numbers are indicated in the embodiments set out above, these are examples and should not be taken as being indicative of being essential to the performance of the invention.

Furthermore, the method of the present invention can be used to address other non-linear problems. Such problems include, but are not limited to, route planning for deliveries and/or collections; the programming of the movements of robot arms during a manufacturing process; planning the layout of a factory floor; modelling global temperature changes in climatology; and portfolio optimisation within financial mathematics. The process is similar to that described above in that a non-deterministic optimisation algorithm is set up and run a multiplicity of times using substantially the same definition of the problem, using substantially the same stopping criteria but using different seeds. The output of each calculation of the algorithm within the study is the determined decision variables and the associated result of the objective function value. The output with substantially the best objective function value is selected as the recommended solution to the problem and the associated variables provided.

The process described above is ideally undertaken using a multiplicity of computers running their calculations in parallel. However, because the run time is so much shorter than systems of the prior art (typically measured in seconds or minutes rather than hours or days) it is possible to reduce the number of computers. For example, if half as many computers are used but a first half of the study is undertaken in a first run of calculations followed by the second half, the total time required is still significantly less than that seen in similar systems of the prior art.

In the main embodiment of the invention disclosed above, the example set out is an offshore windfarm. However, the invention can equally be used in other power generation systems, including, but not limited to, onshore windfarms, wave and tidal point generators and solar panel arrays. Also, in the above example, the wind turbines are given as examples of energy related apparatus and the cables are given as an example of energy conduits. However, the present invention is equally applicable to other forms of energy related apparatus. For example, an arrangement of cables between a multiplicity of car charging terminals in a large carpark can benefit from optimisation of the connecting cables. In this instance, the energy related apparatus are vehicle charging points which consume rather than generate electricity and the cables are significantly shorter and carry less wattage than those of the electricity generating wind turbines described above. It has been proposed that instead of the energy conduit being cables they transfer other forms of energy such as compressed air, hydrogen or other fluid chemicals (for example ammonia) which can be used as an energy source. An example of this would be using a process such as hydrolysis to break water down using electricity generated at a turbine into Hydrogen and Oxygen. The Hydrogen is then piped onshore in a series of pipes which are arranged in a manner similar to the cables described above. It should be noted that the process of the present invention works irrespective of whether calculations in a study are run consecutively or in parallel. However, running in parallel produces the optimisation result in a shorter period of time.

1. A method for estimating an optimum arrangement of energy conduits in an array, comprising the steps:
setting up, on at least one computing device, a non-deterministic mixed integer non-linear programming algorithm to optimise an arrangement of energy conduits in an array as a non-linear optimisation problem, the algorithm producing an output including at least one arrangement of energy conduits and an associated objective function value;
performing, on said at least one computer device, a calculation of said algorithm a plurality of times, in parallel, to produce a plurality of outputs using substantially the same problem definition, using substantially the same stopping criteria and using different seeds; and
analysing, on a said or another computer device, said plurality of outputs to determine the substantially best objective function value and the arrangement of energy conduits associated therewith.

2. A method according to claim 1, wherein said at least one mixed integer non-linear programming algorithm comprises optimising for energy lost in said energy conduit.

3. A method according to claim 1 further comprising analysing said plurality of objective function values to obtain at least one of a probability distribution function of the objective function values; probability distribution function of a calculation time of the chosen algorithm; summary statistics of the objective function values; and summary statistics of the calculation time.

4. A method according to claim 3, further comprising using said probability distribution function or summary statistics of the objective function values to estimate probabilistic bounds of the substantially best objective function value.

5. A method according to claim 1, further comprising, prior to undertaking the method of claim 1:
analysing said plurality of objective function values to obtain at least one of a probability distribution function of the objective function values; probability distribution function of a calculation time of the chosen algorithm; summary statistics of the objective function values;
summary statistics of the calculation time; and using said probability distribution function or summary statistics of the objective function values to estimate probabilistic bounds of the substantially best objective function value in a plurality of studies, each study using different stopping criteria;
using at least one said distribution function to predict probabilistic bounds at different numbers of calculations to estimate a best balance of number of calculations and stopping criteria to efficiently estimate an optimum arrangement of energy conduits in an array; and
running a further study according to claim 1, to estimate an optimum arrangement of energy conduits in an array with said best balance of number of calculations and stopping criteria.

6. A method according to claim 5, wherein at least one empirical relationship is determined between said stopping criteria and said distribution functions and/or said summary statistics.

7. A method according to claim 1, wherein said objective function value is determined including at least one of:
the cost of the energy conduit;
the energy lost in said energy conduit;
the energy lost due to power losses in the energy conduit;
the energy lost due to outages;
the cost to maintain the energy conduit;
the cost to repair the energy conduit;
the amount of energy reaching a given point in the array or energy conduits;
the value of energy passing along the energy conduits; and
the cost of installing said energy conduit.

8. A method according to claim 1, further comprising one or more of the following features:
a) wherein said plurality of outputs are used to produce a heatmap of arrangements to provide said estimated optimum arrangement;
b) wherein said energy conduits comprise cables;
c) wherein said cables connect a plurality of energy generation devices to at least one node; and
d) wherein said energy generation devices comprise wind turbines.

9. A method according to claim 1 wherein said stopping criteria results in an average runtime for a single run of the algorithm of less than 60 minutes or less than 30 minutes or less than 15 minutes or less than 10 minutes.

10. A method according to claim 1 wherein said multiplicity of computers comprises at least 10 computers or at least 25 computers or at least 32 computers or at least 50 computers or at least 100 computers or at least 1000 computers.

11. A method of installing an array of interconnected energy related apparatus, comprising the steps:
determining the locations of an array of energy related apparatus;
using at least one computer device to
set up a non-deterministic mixed integer non-linear programming algorithm to optimise an arrangement of energy conduits in an array as a non-linear optimisation problem, the algorithm producing an output including at least one arrangement of energy conduits and an associated objective function value;
perform a calculation of said algorithm a plurality of times, in parallel, to produce a plurality of outputs using substantially the same problem definition, using substantially the same stopping criteria and using different seeds; and
analyse said plurality of outputs to determine the substantially best objective function value and the arrangement of energy conduits associated therewith to estimate an optimum arrangement of energy conduits interconnecting said array; and
installing said energy related apparatus and said arrangement of energy conduits.

12. A method according to claim 11, wherein said energy conduits comprise cables.

13. A method according to claim 11, wherein said energy related devises comprise energy generation devices.

14. A method for estimating a solution to a non-deterministic problem, comprising the steps:
setting up, on at least one computer device, a non-deterministic mixed integer non-linear programming algorithm to optimise a non-linear optimisation problem, the algorithm producing an output including an example solution to the problem and an associated objective function value;
performing, on said at least one computer device, a calculation of said algorithm a plurality of times, in parallel, to produce a plurality of outputs using substantially the same problem definition, using substantially the same stopping criteria and using different seeds; and
analysing, on a said or another computer device, said plurality of outputs to determine the substantially best objective function value and the example solution associated therewith.

15. A method according to claim 14, further comprising analysing said plurality of objective function values to obtain at least one of a probability distribution function of the objective function values; probability distribution function of a calculation time of the chosen algorithm; summary statistics of the objective function values; and summary statistics of the calculation time.

16. A method according to claim 15, further comprising using said probability distribution function or summary statistics of the objective function values to estimate probabilistic bounds of the substantially best objective function value.

17. A method according to claim 14, further comprising, prior to undertaking the method of claim 12:
analysing said plurality of objective function values to obtain at least one of a probability distribution function of the objective function values; probability distribution function of a calculation time of the chosen algorithm; summary statistics of the objective function values; summary statistics of the calculation time; and using said probability distribution function or summary statistics of the objective function values to estimate probabilistic bounds of the substantially best objective function value in a plurality of studies, each study using different stopping criteria;
using at least one said distribution function to predict probabilistic bounds at different numbers of calculations to estimate a best balance of number of calculations and stopping criteria to efficiently estimate an optimum example solution to the problem; and
running a further study according to claim 14 to estimate an optimum example solution to the problem with said best balance of number of calculations and stopping criteria.

18. A method according to claim 17, wherein at least one empirical relationship is determined between said stopping criteria and said distribution functions and/or said summary statistics.

19. A method according to claim 14 wherein said stopping criteria results in an average runtime for a single run of the algorithm of less than 60 minutes or less than 30 minutes or less than 15 minutes or less than 10 minutes.

20. A method according to claim 14 wherein said multiplicity of computers comprises at least 10 computers or at least 25 computers or at least 32 computers or at least 50 computers or at least 100 computers or at least 1000 computers.
